(19) United States
(12) Patent Application Publication
(10) Pub. No.: US 2026/0261902 A1
(43) Pub. Date: Sep. 3, 2026

(54) DATA TRANSMISSION

(71) Applicant: Tencent Technology (Shenzhen) Company Limited, Shenzhen (CN)

(72) Inventors: Yixue LEI, Shenzhen (CN); Yuhang JIA, Shenzhen (CN); Chao HUANG, Shenzhen (CN)

(73) Assignee: Tencent Technology (Shenzhen) Company Limited, Shenzhen (CN)

(21) Appl. No.: 19/675,163

(22) Filed: May 12, 2026

Related U.S. Application Data
(63) Continuation of application No. PCT/CN2025/136235, filed on Nov. 20, 2025.

(30) Foreign Application Priority Data
Dec. 16, 2024 (CN) 202411865694.5

(51) Int. Cl. H04W 28/02; H04L 43/0852; H04W 28/06; H04W 56/00

(52) U.S. Cl. CPC H04W 28/0268; H04L 43/0852; H04W 28/06; H04W 56/0015

(57) ABSTRACT

Some aspects of the disclosure provide a method of data transmission. In some examples, a synchronization relationship among a plurality of quality of service (QoS) flows is recognized. When the synchronization relationship among the plurality of QoS flows is recognized, a synchronization parameter associated with the plurality of QoS flows is obtained. When a network transmission quality indicates a need for packet discarding, at least a target QoS flow in the plurality of QoS flows that fails to satisfy a synchronization requirement to other QoS flows in the plurality of QoS flows is selected based on the synchronization parameter. At least a target data packet in the target QoS flow is discarded. Apparatus and non-transitory computer-readable storage medium counterpart embodiments are also contemplated.

### RELATED APPLICATIONS

The present application is a continuation of International Application No. PCT/CN2025/136235, filed on November 20, 2025, which claims priority to Chinese Patent Application No. 202411865694.5, filed on December 16, 2024. The entire disclosures of the prior applications are hereby incorporated by reference.

### FIELD OF THE TECHNOLOGY

This disclosure relates to the field of computer and communication technologies, including a data transmission method and apparatus, a computer-readable medium, and an electronic device.

### BACKGROUND

In 5^{th}-Generation (5G) and subsequent evolved systems (such as 5G-Advanced (5G-A) and 6^{th}-Generation (6G)), high-bandwidth interactive services are important service types, such as cloud gaming, virtual reality (VR), augmented reality (AR), mixed reality (MR), extended reality (XR), cinematic reality (CR), and XR and media services (XRM). These high-bandwidth interactive services impose stringent requirements on transmission timeliness, and moreover, service flows of such services usually include a plurality of media types, such as audio, video, and haptic media. During transmission, service flows of different media types may be mapped to different quality of service (QoS) flows.

However, while supporting a large quantity of users in performing various immersive media services, the radio transmission of a network is prone to congestion. In this case, packet discarding may need to be performed on data packets to solve the problem of network congestion. In the related art, packet discarding is usually performed based on the importance of a data packet. However, such a solution may have a problem of asynchronous service data of different media types when handling a plurality of associated QoS flows.

### SUMMARY

Embodiments of this disclosure include a data transmission method and apparatus, a computer-readable medium, and an electronic device. A synchronization parameter can be introduced to make packet discarding decisions for a plurality of QoS flows, so that synchronization among different QoS flows and overall service quality can be maintained in a case of network congestion.

Some aspects of the disclosure provide a method of data transmission. In some examples, a synchronization relationship among a plurality of quality of service (QoS) flows is recognized. When the synchronization relationship among the plurality of QoS flows is recognized, a synchronization parameter associated with the plurality of QoS flows is obtained. When a network transmission quality indicates a need for packet discarding, at least a target QoS flow in the plurality of QoS flows that fails to satisfy a synchronization requirement to other QoS flows in the plurality of QoS flows is selected based on the synchronization parameter. At least a target data packet in the target QoS flow is discarded.

Some aspects of the disclosure provide an apparatus that includes processing circuitry configured to perform any of the methods described herein.

Some aspects of the disclosure provide a non-transitory computer-readable storage medium storing instructions which when executed by at least one processor cause the at least one processor to perform any of the methods described herein.

According to a first aspect, an embodiment of this disclosure provides a data transmission method, including: recognizing a synchronization relationship among a plurality of QoS flows; obtaining, if the synchronization relationship among the plurality of QoS flows is recognized, a synchronization parameter among the plurality of QoS flows; and discarding, if it is determined, according to network transmission quality, that packet discarding needs to be performed, a target data packet in the plurality of QoS flows according to the synchronization parameter.

According to a second aspect, an embodiment of this disclosure provides a data transmission apparatus, including: a recognition unit, configured to recognize a synchronization relationship among a plurality of QoS flows; an obtaining unit, configured to obtain, if the synchronization relationship among the plurality of QoS flows is recognized, a synchronization parameter among the plurality of QoS flows; and a processing unit, configured to discard, if it is determined, according to network transmission quality, that packet discarding needs to be performed, a target data packet in the plurality of QoS flows according to the synchronization parameter.

According to a third aspect, an embodiment of this disclosure provides a computer-readable medium (e.g., non-transitory computer-readable storage medium), having a computer program stored therein. The computer program, when executed by a processor (an example of processing circuitry), implements the data transmission method according to the foregoing embodiment.

According to a fourth aspect, an embodiment of this disclosure provides an electronic device, including one or more processors and a storage apparatus configured to store one or more computer programs. The one or more computer programs, when executed by the one or more processors, cause the electronic device to implement the data transmission method according to the foregoing embodiment.

According to a fifth aspect, an embodiment of this disclosure provides a computer program product. The computer program product includes a computer program. The computer program is stored in a computer-readable storage medium (e.g., non-transitory computer-readable storage medium). A processor of an electronic device reads and executes the computer program from the computer-readable storage medium, to cause the electronic device to perform the data transmission method according to the foregoing embodiments.

In the technical solutions provided in some embodiments of this disclosure, when the synchronization relationship among the plurality of QoS flows is recognized, the synchronization parameter among the plurality of QoS flows is obtained, and further, when it is determined, according to the network transmission quality, that packet discarding needs to be performed, the target data packet in the plurality of QoS flows is discarded according to the synchronization parameter. Therefore, the synchronization parameter can be introduced to make packet discarding decisions for the plurality of QoS flows, and a more intelligent packet discarding mechanism among the plurality of QoS flows having the synchronization relationship is implemented, so that synchronization among different QoS flows and overall service quality can be maintained in a case of network congestion.

The foregoing general descriptions and the following detailed descriptions are for illustration and explanation purposes and are not intended to limit this disclosure.

### BRIEF DESCRIPTION OF THE DRAWINGS

FIG. 1 is a schematic diagram of a system architecture to which the technical solutions in the embodiments of this disclosure may be applied.

FIG. 2 is a schematic diagram of a transmission process of a multimedia data packet according to various embodiments of this disclosure.

FIG. 3 is a schematic diagram of performing data transmission using a plurality of QoS flows according to various embodiments of this disclosure.

FIG. 4 is a flowchart of a data transmission method according to various embodiments of this disclosure.

FIG. 5 is a flowchart of a data transmission method according to various embodiments of this disclosure.

FIG. 6 is a flowchart of a data transmission method according to various embodiments of this disclosure.

FIG. 7 is a block diagram of a data transmission apparatus according to various embodiments of this disclosure.

FIG. 8 is a schematic structural diagram of a computer system adapted to implement an electronic device according to various embodiments of this disclosure.

### DETAILED DESCRIPTION

The following describes technical solutions in embodiments of this disclosure with reference to the accompanying drawings. The described embodiments are some of the embodiments of this disclosure rather than all of the embodiments. Other embodiments are within the scope of this disclosure.

In the embodiments of this disclosure, the term "module" or "unit" refers to a computer program having a predetermined function or a part of a computer program, and works together with other relevant parts to achieve a predetermined objective, and may be in whole or in part implemented using software, hardware (such as a processing circuit or a memory), or a combination thereof. Similarly, one processor (or a plurality of processors or memories) may be used to implement one or more modules or units. In addition, each module or unit may be a part of an overall module or unit including a function of the module or unit.

The block diagrams shown in the accompanying drawings are functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are descriptions, and do not necessarily include all contents and operations/steps, nor necessarily need to be performed in the described sequence. For example, some operations/steps may be further divided, while some operations/steps may be combined or partially combined. Therefore, an actual execution order may change according to an actual situation.

"Plurality of" herein means two or more. "And/or" describes an association relationship for describing associated objects and represents that three relationships may exist. For example, A and/or B may represent the following three cases: only A exists, both A and B exist, and only B exists. The character "/" in this disclosure generally indicates an "or" relationship among the associated objects.

With the development of 5G and subsequent evolved systems (such as 5G-A and 6G), many multimedia services that require large data volume and short latency have been applied, for example, interaction services such as cloud gaming service, VR, AR, MR, XR, or CR.

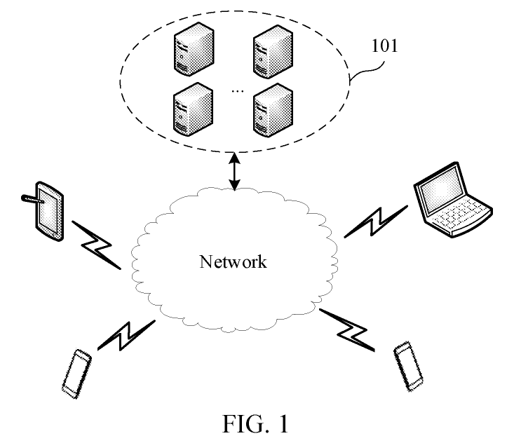

For example, in a cloud gaming scenario shown in FIG. 1, a cloud server 101 is configured to run cloud gaming. The cloud server 101 may render a game picture, encode an audio signal and a rendered image, and finally transmit encoded data obtained through encoding to each game client through a network. The game client may be a user equipment (UE) having basic streaming media playing capability, human-computer interaction capability, communication capability, and the like, such as a smartphone, a tablet computer, a notebook computer, a desktop computer, a smart television, a smart home, an on board terminal, or an aircraft. Alternatively, the game client may be an application running in a terminal device. For example, the game client may decode the encoded data transmitted by the cloud server 101, to obtain analog audio and video signals, and play an audio and a video.

FIG. 1 represents an example of system architecture of a cloud gaming system, and does not limit the specific architecture of the cloud gaming system. For example, in other embodiments, the cloud gaming system may further include a backend server for scheduling, and the like. The cloud server 101 may be an independent physical server, or may be a server cluster formed by a plurality of physical servers or a distributed system, or may be a cloud server providing basic cloud computing services such as cloud service, a cloud database, cloud computing, a cloud function, cloud storage, a network service, cloud communication, a middleware service, a domain name service, a security service, a content delivery network (CDN), and a big data and artificial intelligence platform. The game client and the cloud server 101 may be directly or indirectly connected in a wired or wireless communication manner. This is not limited herein in this disclosure.

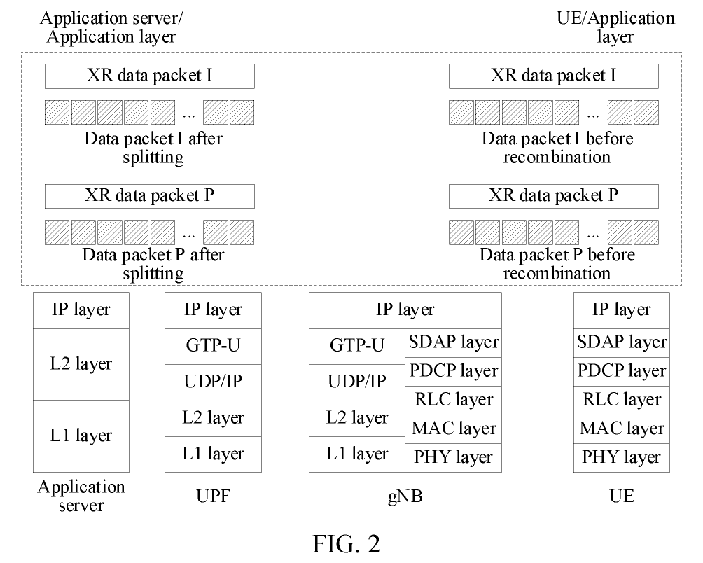

In the foregoing various multimedia-based interactive service application scenarios, because a multimedia data packet is large, for example, even a single multimedia service frame or a group of packets (GoP) may be of large size, during transmission, the multimedia data packet needs to be split into a plurality of data packets for transmission. In some examples, as shown in FIG. 2, using a 5G system as an example, a user plane mainly includes an application server, a user plane function (UPF), a next generation nodeB (gNB), and a UE. For some typical service scenarios, a multimedia data packet is transmitted mainly in a downlink direction, for example, from the application server (AS) to the UPF, and then is transmitted to the UE through the gNB. During transmission, the multimedia data packets (taking XR data packets I and P as an example in FIG. 2) are split at an application layer of the application server. After the sub-data packets (sub-data packets I1, I2 … and sub-data packets P1, P2 …) arrive at the UPF as IP packets from the application server, the 5G system transmits the sub-data packets to the UE end using a protocol data unit (PDU) session. At the UE end, the sub-data packets are submitted up a protocol stack level by level and recombined to recover the multimedia data packet. A protocol stack of a UE end includes, from bottom to top, a physical (PHY) layer, a media access control (MAC) layer, a radio link control (RLC) layer, a packet data convergence protocol (PDCP) layer, a service data adaptation protocol (SDAP) layer, and an Internet Protocol (IP) layer.

In the system shown in FIG. 2, the L1 layer refers to a physical layer, which is configured to ensure that original data can be transmitted on various physical media. The L2 layer refers to a data link layer, and the data link layer provides a service for a network layer based on a service provided by the physical layer. The Internet Protocol (IP) layer is the network layer, which is configured to implement data transmission between two end systems. UDP refers to user datagram protocol. GTP-U refers to general packet radio service (GPRS) tunneling protocol user plane. PHY is short for physical. MAC refers to media access control. RLC refers to radio link control. PDCP refers to packet data convergence protocol. SDAP refers to service data adaptation protocol.

As described above, for a multimedia service (such as an XRM service), transmitting one frame of multimedia data using a plurality of data packets is common. Data formed by a single multimedia service frame or group of packets (GoP) may also be of large size, and may be carried by a series of IP data packets. There is a correlation among the IP data packets, and processing the IP data packets according to the correlation can save the radio network bandwidth. For example, a plurality of IP data packets may be transmitted during transmission, and the plurality of IP data packets may form a PDU set.

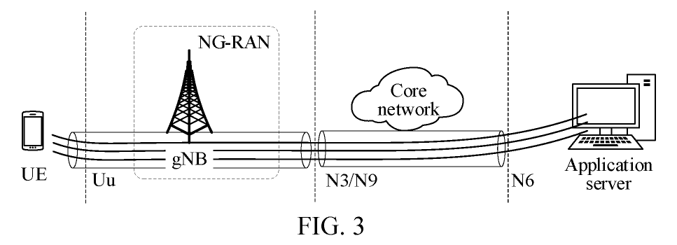

A service flow of a multimedia service (such as an XRM service) usually includes a plurality of media types, such as audio, video, and haptic media. As shown in FIG. 3, during transmission, to ensure quality of service, service flows of different media types between a user equipment and an application server may be mapped to different quality of service (QoS) flows. Different QoS flows may have different time latencies during transmission. For example, transmission latencies between a radio access network (RAN) and a UPF may be different. Further, a problem of asynchronous service data of different media types may occur when a receiving end (for example, the user equipment) generates, according to received service flows of a plurality of media types, media content for playing.

In addition, while supporting a large quantity of users in performing various immersive media services, the radio transmission of a network is prone to congestion. This not only affects user experience, but also may cause redundant data generated in a media encoding/decoding process to be unable to be effectively processed. In the related art, in a case of network congestion, packet discarding is usually performed based on the importance of a data packet. However, such a solution may have a problem of asynchronous service data of different media types when handling a plurality of associated QoS flows.

For example, for a scenario in which an audio stream and a video stream are transmitted using different QoS flows, assuming that the audio stream and the video stream need to be synchronized and importance of data packets in the audio stream is higher than importance of data packets in the video stream, if network congestion occurs, in the related art, the data packets in the video stream are preferentially discarded. In this case, if a latency of the audio stream is relatively large (for example, larger than a latency of the video stream), even if the data packets in the video stream are discarded to ensure that the data packets in the audio stream are continuously transmitted, there is no benefit in achieving synchronization between the audio stream and the video stream. In other words, the solution of performing packet discarding based on importance provided in the related art lacks consideration about synchronization between different QoS flows. Therefore, when network congestion occurs, such a packet discarding mechanism may not effectively maintain synchronization between multimodal data flows, thereby affecting final user experience.

Based on the foregoing problem, the technical solution of the embodiments of this disclosure provides a new data transmission solution. A synchronization parameter can be introduced to make packet discarding decisions for a plurality of QoS flows, and a more intelligent packet discarding mechanism among the plurality of QoS flows having the synchronization relationship is implemented, so that synchronization among different QoS flows and overall service quality can be maintained in a case of network congestion, thereby solving the problem of asynchronous service data of different media types when performing packet discarding based on importance of data packets in the related art.

The implementation details of the technical solution of the embodiments of this disclosure are described in further detail below.

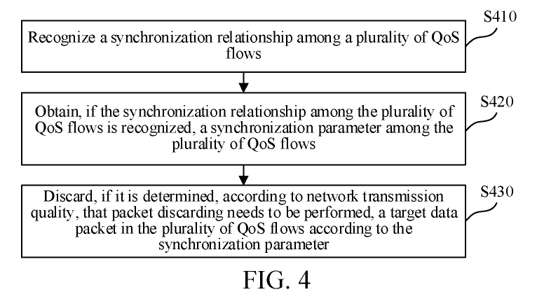

FIG. 4 is a flowchart of a data transmission method according to various embodiments of this disclosure. The data transmission method may be performed by an access network element, for example, by a gNB device. The technical solution of the embodiment shown in FIG. 4 may also be performed by another electronic device having a computing processing function, for example, by a user equipment or a UPF. As shown in FIG. 4, the data transmission method includes S410 to S420, which will be described in further detail as follows:

S410: Recognize a synchronization relationship among a plurality of QoS flows.

In some embodiments, the plurality of QoS flows may be obtained by mapping data flows of different media types of a multimedia service. The media types may include audio, video, haptic media, or another media type. Service data packets of different media types may have different QoS requirement information, or may have the same QoS requirement information. If service data packets of different media types have different QoS requirement information, the service data packets of the different media types may be mapped to different QoS flows.

The multimedia service may be, for example, a cloud gaming service, a VR service, an AR service, an MR service, an XR service, an XRM service, or a CR service. The data packets of the multimedia service may be transmitted in a form of a protocol data unit set (PDU set). This is because if a single multimedia service frame or GoP forms a data packet, the data packet may be of large size, and therefore, needs to be split into a series of data packets for carrying. There is a correlation among this series of data packets. Therefore, these correlated data packets may be referred to as a PDU set. In other embodiments of this disclosure, the service data flows may alternatively be transmitted in a per-packet manner.

Using a cloud gaming service as an example, the cloud gaming service may include service data packets of an audio type, service data packets of a video type, or service data packets of a haptic media or another type. Because the service flow data packets of the multiple media types are associated with the same multimedia service, if the service flow data packets are mapped to different QoS flows during transmission, these QoS flows are associated. For example, there is a synchronization requirement among the QoS flows, that is, the latency among the QoS flows is to be consistent or within a latency range.

In some embodiments, indication information transmitted by the core network element may be received, and then whether the plurality of QoS flows have a synchronization relationship may be recognized according to the indication information. For example, according to the indication information, whether the plurality of QoS flows in the same PDU session have the synchronization relationship, or whether the QoS flows in different PDU sessions have the synchronization relationship is recognized in an explicit manner.

For example, the indication information transmitted by the core network element may be a multi-modality service identifier (MMSID), and the multi-modality service identifier is configured for indicating that a plurality of QoS flows in the same PDU session have a synchronization relationship.

In some embodiments, whether the plurality of QoS flows have a synchronization relationship may also be recognized in an implicit manner. For example, whether the plurality of QoS flows have the synchronization relationship may be recognized according to the PDU session and UE context.

In some examples, in the UE Context, the QoS is usually associated with a particular session (such as a bearer in an evolved packet system (EPS) or a QoS flow in a 5G system (5GS)). The QoS parameters may include: priority, configured to determine a transmission sequence of the data packets; rate limit, such as maximum bit rate (MBR) or guaranteed bit rate (GBR), configured to control a data transmission speed; packet filter set, configured to associate data packets in a network with a specific QoS rule; and QoS rule identifier (such as QoS class identifier (5QI) or allocation and retention priority (ARP)), configured for uniquely identifying a QoS rule. When whether the QoS flows have a synchronization relationship is recognized according to a session level included in the UE Context, the UE context may be searched for QoS parameters associated with a specific session, and then whether the plurality of QoS flows have a synchronization relationship may be recognized based on these parameters. In various embodiments of this disclosure, "parameter" may refer to a measurable attribute (the parameter itself), a parameter value, or both.

In some embodiments, when whether the plurality of QoS flows have a synchronization relationship is recognized in an implicit manner, whether the plurality of QoS flows have a synchronization relationship may be recognized according to the QoS parameter of the QoS flow level.

In some examples, the QoS flow is the finest QoS differentiation granularity in the PDU session, and each QoS flow is configured and managed based on a series of QoS parameters. These parameters not only define characteristics of the QoS flows, but also indirectly reflect the association between the QoS flows. The QoS parameters of the QoS flow level may include QoS flow identifier (QFI), QoS class identifier (5QI), allocation and retention priority (ARP), guaranteed flow bit rate (GFBR), maximum flow bit rate (MFBR), and the like.

The QFI is configured for identifying a QoS flow. The 5QI is configured for indexing a 5G QoS characteristic. Different 5QI values represent different QoS categories, and QoS flows having the same 5QI value may have a similarity in QoS processing. The ARP parameter defines the priority, preemption capability, and preemptability of a QoS flow. QoS flows having the same ARP parameter may be subject to the same processing policy during resource allocation. For a GBR QoS flow, GFBR and MFBR respectively represent the guaranteed bit rate and the maximum bit rate, and QoS flows having similar GFBR and the MFBR values may be associated in rate guarantee. Therefore, whether the plurality of QoS flows have a synchronization relationship may be recognized based on the QoS parameters of the QoS flow level. For example, whether different QoS flows have the same ARP parameter or the same latency parameter may be recognized according to the QFI. If the different QoS flows have the same latency parameter or similar latency parameters (for example, a value of the latency parameter is less than a preset threshold), the different QoS flows are synchronous.

For example, in addition to the foregoing QoS parameters, for a service data packet transmitted by a PDU set, the corresponding QoS parameter may also include at least one of the following parameters: PDU set latency budget (PSDB), PDU set error rate (PSER), maximum data burst volume (MDBV), and packet latency variation/jitter (PDV). For a service data packet transmitted in a per-packet form, the QoS parameter may also include at least one of the following parameters: packet latency budget (PDB), packet error rate (PER), maximum data burst volume, and the like.

In some embodiments, when whether the plurality of QoS flows have a synchronization relationship is recognized in an implicit manner, in a case that the core network element indicates a synchronization requirement, the plurality of QoS flows included in the same PDU session may be recognized as having the synchronization relationship. That is, in this embodiment, the plurality of QoS flows included in the same PDU session are recognized as the QoS flows having the synchronization relationship, without indication of other parameters.

S420: Obtain, if the synchronization relationship among the plurality of QoS flows is recognized, a synchronization parameter among the plurality of QoS flows.

In some embodiments, the obtaining a synchronization parameter among the plurality of QoS flows may be obtaining a threshold of a synchronization time difference among the plurality of QoS flows. The threshold is configured for a maximum time synchronization error among the plurality of QoS flows. In other words, the synchronization parameter may be configured for indicating a condition for implementing synchronization of the plurality of QoS flows. For example, if the time synchronization error between two QoS flows exceeds the threshold, the two QoS flows have lost synchronization.

The indication information of the synchronization parameter transmitted by the core network element may be received, and further, the synchronization parameter configured by the core network element can be obtained according to the indication information.

The synchronization parameter among the plurality of QoS flows may also be determined according to types of the plurality of QoS flows. For example, the maximum time synchronization error among different types of QoS flows may be preset. Therefore, during transmission of the plurality of QoS flows, the maximum time synchronization error can be determined according to the types of the plurality of QoS flows. In some examples, for example, the maximum time synchronization error between an audio stream and a video stream is preset to 20 ms. If an audio stream and a video stream that have a synchronization relationship are recognized, it may be determined that a synchronization parameter between the audio stream and the video stream is 20 ms, that is, the maximum time synchronization error between the audio stream and the video stream is 20 ms.

S430: Discard, if it is determined, according to network transmission quality, that packet discarding needs to be performed, a target data packet in the plurality of QoS flows according to the synchronization parameter. For example, the target data packet in the plurality of QoS flows is discarded, to meet the synchronization requirement determined according to the synchronization parameter.

In some embodiments, if network transmission quality is poor, it may be determined that packet discarding needs to be performed. Poor network transmission quality may be determined using set indicators. These indicators may be, for example, packet loss rate, latency, jitter, throughput, retransmission rate, signal strength, and signal quality.

The packet loss rate (PLR) is a proportion of data packets that cannot be successfully delivered to a destination to total transmitted data packets in a network transmission process. A high packet loss rate is usually a sign of network congestion or failure. For a real-time communication service such as a voice call and a video conference, even a small quantity of packet losses may significantly affect user experience. The latency refers to a time interval between the transmission of data from a transmitting end and the reception of the data by a receiving end. A low latency is crucial for real-time applications. For example, for an online game, AR/VR experience, or the like, an excessive latency time may cause a significant data lag at the receiving end, affecting interaction experience. The jitter is a difference between arrival times of adjacent data packets, that is, a latency variation. Large jitter affects playing smoothness of an audio stream and a video stream, causing frame freezing, especially in a real-time interaction scenario. The throughput represents a data volume transmitted by a network in a unit time. When the actual throughput is lower than an expected value, it may mean that the network bandwidth is insufficient or other limiting factors such as channel interference or device performance bottleneck exist. The retransmission rate is the proportion of data packets that need to be retransmitted due to loss or damage to total transmitted data packets in a network connection. Frequent retransmission not only increases the latency, but also wastes precious network resources, and reduces overall transmission efficiency. The signal strength may be reference signal received power (RSRP). The signal quality may be reference signal received quality (RSRQ). Low signal strength or poor signal quality may cause a higher error rate and a lower transmission rate.

In some embodiments, when the target data packets in the plurality of QoS flows are discarded according to the synchronization parameter, according to a synchronization requirement determined by the synchronization parameter, a target QoS flow in the plurality of QoS flows that does not meet the synchronization requirement with respect to the other QoS flows may be determined, and then one or more data packets in the target QoS flow may be selected as the target data packet to be discarded. According to the technical solution of this embodiment, when the network transmission quality is poor, some data packets in the QoS flows that do not meet the synchronization requirement may be preferentially discarded. For example, when an audio stream and a video stream are synchronously transmitted, if the audio stream has a large latency and cannot be synchronized with the video stream, some data packets in the audio stream may be preferentially discarded when network quality is poor. In this way, the data packets in the audio stream that do not meet the synchronization requirement can be discarded, and the data packets in the audio stream that can be synchronized with the video stream can be transmitted, thereby better maintaining time consistency of multimodal data flows, and helping ensure quality of user experience.

In some embodiments, if it is detected that a transmission latency between the target QoS flow and the other QoS flows in the plurality of QoS flows is greater than or equal to a latency threshold indicated by the synchronization parameter, it can be determined that the target QoS flow does not meet the synchronization requirement with respect to the other QoS flows. For example, the latency threshold is mainly configured for indicating a maximum time synchronization error among the plurality of QoS flows. If the transmission latency between the two QoS flows is greater than the latency threshold, the time synchronization error between the two QoS flows is also greater than the set maximum time synchronization error. In this case, it can be determined that the two QoS flows already do not meet the synchronization requirement, and the QoS flow having the larger latency may be used as the determined target QoS flow.

In some embodiments, if it is determined, according to the network transmission quality, that packet discarding needs to be performed, but it is determined, according to the synchronization requirement determined by the synchronization parameter among the plurality of QoS flows, that the plurality of QoS flows meet the synchronization requirement, some data packets may be selected, according to an ascending order of priorities of the data packets in the plurality of QoS flows, as the target data packets to be discarded from the data packets in the plurality of QoS flows. In other words, in this embodiment of this disclosure, if it is determined, according to the network transmission quality, that packet discarding needs to be performed, some data packets in the QoS flows that do not meet the synchronization requirement may be preferentially discarded, and if all the QoS flows meet the synchronization requirement, the data packets are discarded according to an ascending order of priorities of the data packets. For example, when the data packets in the plurality of QoS flows are discarded in the ascending order of the priorities of the data packets in the plurality of QoS flows, packet discarding may be performed on each QoS flow in an ascending order of the priorities of the data packets; or packet discarding may be performed on some QoS flows (for example, randomly selected QoS flows or QoS flows with lower priority) in the plurality of QoS flows according to an ascending order of priorities of the data packets; or the data packets in the plurality of QoS flows may be put together, and packet discarding is performed according to an ascending order of the priorities.

In some embodiments, in the packet discarding process, if it is detected that the network transmission quality returns to normal, the packet discarding on the plurality of QoS flows may be stopped. For example, that the network transmission quality returns to normal means that the network transmission quality returns to a stable condition without congestion. In this case, packet discarding may not be performed again, which may be specifically determined according to the indicators set in the foregoing embodiment.

In some embodiments, in the packet discarding process, if it is detected that a proportion of the discarded data packets in a QoS flow (or the discarded data packets in a PDU set) reaches a set tolerable packet loss proportion, the packet discarding on the QoS flow may be stopped (or the packet discarding on the PDU set may be stopped). The tolerable packet loss proportion is configured for representing a maximum allowable packet loss proportion, which may be, for example, a maximum proportion of data packets that are allowed to be discarded on the premise of ensuring that the data receiving end can normally decode the other data packets in the service data flow. In the technical solution of this embodiment, when a proportion of the discarded data packets in a QoS flow (or a PDU set) reaches a set tolerable packet loss proportion, the data packets in the QoS flow (or the PDU set) are no longer discarded. This prevents excessive packet loss from rendering the data receiving end incapable of recovering the other data packets in the QoS flow (or the PDU set). In other words, the tolerable packet loss proportion may be for the QoS flow or for the PDU set.

In some embodiments, the tolerable packet loss proportion may be determined according to a forward error correction (FEC) configuration parameter of the service data flow. For example, if the service data flow employs the forward error correction and can tolerate 10% packet loss, the tolerable packet loss proportion is 10%.

In some embodiments, the tolerable packet loss proportion may be determined according to an attribute parameter of the service data flow, for example, according to one or more of a frame rate and a resolution of the service data flow. In some examples, if the dropped frames can be recovered by interpolation, fitting, or the like due to setting of the frame rate or resolution of the service data flow, discarding of some data packets can be tolerated, and the tolerable packet loss proportion can be set accordingly.

In some embodiments, the tolerable packet loss proportion may alternatively be associated with a latency requirement of the service data flow. For example, after the latency requirement of the service data flow is exceeded, transmission of the data packets in the service data flow to the receiving end may be of little significance. Therefore, a relatively large tolerable packet loss proportion may be set after the latency of the service data flow exceeds the latency requirement. For example, the latency requirement of the service data flow may be PSDB, PDB, or the like.

In some embodiments, the tolerable packet loss proportion of the service data flow may also be determined based on two or all of the forward error correction configuration parameter of the service data flow, the attribute parameter of the service data flow, and the latency requirement of the service data flow.

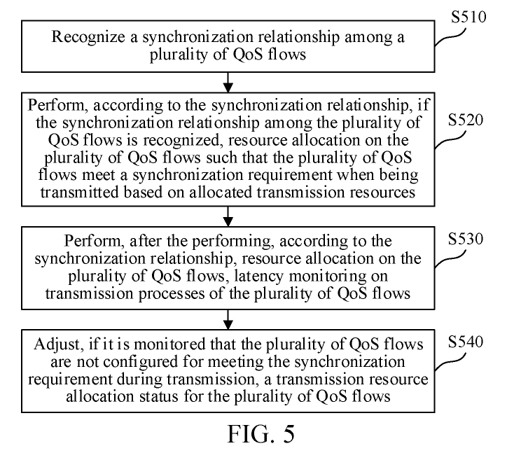

FIG. 5 is a flowchart of a data transmission method according to various embodiments of this disclosure. The data transmission method may be performed by an access network element, for example, by a gNB device. The technical solution of the embodiment shown in FIG. 5 may also be performed by another electronic device having a computing processing function, for example, by a user equipment or a UPF. As shown in FIG. 5, the data transmission method includes S510 to S540, which will be described in further detail as follows:

S510: Recognize a synchronization relationship among a plurality of QoS flows.

For example, for specific implementation details of S510, reference may be made to related descriptions of S410 in the foregoing embodiment, and details are not described herein again.

S520: Perform, according to the synchronization relationship, if the synchronization relationship among the plurality of QoS flows is recognized, resource allocation on the plurality of QoS flows such that the plurality of QoS flows meet the synchronization requirement when being transmitted based on allocated transmission resources. The synchronization requirement is preset and/or indicated by a synchronization parameter transmitted by a core network element.

In some embodiments, when resource allocation is performed on the plurality of QoS flows according to the synchronization relationship among the plurality of QoS flows, if the plurality of QoS flows are configured for meeting the synchronization requirement when being transmitted using the same data radio bearer (DRB), the plurality of QoS flows may be transmitted using the same data radio bearer such that the plurality of QoS flows can meet the synchronization requirement when being transmitted based on the same data radio bearer. If the plurality of QoS flows are not configured for meeting the synchronization requirement when being transmitted using the same DRB, different data radio bearers may be allocated to the plurality of QoS flows such that the plurality of QoS flows can meet the synchronization requirement when being transmitted based on the different data radio bearers.

S530: Perform, after the performing, according to the synchronization relationship, resource allocation on the plurality of QoS flows, latency monitoring on transmission processes of the plurality of QoS flows.

Data packets may be transmitted in a transparent mode (TM), an acknowledged mode (AM), and an unacknowledged mode (UM). In the transparent mode (TM), a device or a system for transmitting data is "transparent" to the transmitted data, for example, does not modify or process content of the data. When data is transmitted in the unacknowledged mode (UM), the receiving end does not need to wait for confirmation, and the transmitting end does not wait for any feedback from the receiving end after transmitting the data. Therefore, data transmission efficiency is relatively high. Therefore, the unacknowledged mode is applicable to a scenario that requires high real-time performance but low data transmission accuracy. The acknowledged mode (AM) is a more reliable transmission mode. In the AM mode, the transmitting end needs to wait for an acknowledgement message of the receiving end after transmitting data, to ensure that the data is correctly received. If the receiving end does not receive the data or the data is incorrect, the receiving end transmits a negative acknowledgement (NACK) message to the transmitting end, to request the transmitting end to retransmit the data. This mechanism can ensure integrity and accuracy of data, but correspondingly, some transmission latency is added.

In some embodiments, if the transmission mode of the plurality of QoS flows is the unacknowledged mode, latency monitoring is performed on an uplink transmission process of the plurality of QoS flows by an RLC instance configured to receive the plurality of QoS flows, and latency monitoring is performed on a downlink transmission process of the plurality of QoS flows by an RLC instance configured to transmit the plurality of QoS flows.

In some embodiments, if the transmission mode of the plurality of QoS flows is the acknowledged mode, because the reception of the plurality of QoS flows and the transmission of the plurality of QoS flows are performed by the same RLC instance, latency monitoring may be performed on the transmission processes of the plurality of QoS flows by an RLC instance configured to receive the plurality of QoS flows and transmit the plurality of QoS flows.

In some embodiments, when latency monitoring is performed on the transmission processes of the plurality of QoS flows, whether the plurality of QoS flows meet the synchronization requirement may be monitored using a data packet as a unit, or whether the plurality of QoS flows meet the synchronization requirement may be monitored using a transport block (TB) as a unit.

In some embodiments, if a transmission latency among the data packets of the plurality of QoS flows is within a set threshold range, it may be determined that the plurality of QoS flows are configured for meeting the synchronization requirement during transmission; or if the transmission latency among the data packets of the plurality of QoS flows is not within the set threshold range, it may be determined that the plurality of QoS flows are not configured for meeting the synchronization requirement during transmission. The technical solution of this embodiment can ensure that a plurality of QoS flows are considered to be synchronous when the transmission latency of the plurality of QoS flows is within a particular range, thereby avoiding misjudgments caused by latency jitter.

In some embodiments, when latency monitoring is performed on the transmission processes of the plurality of QoS flows, a state machine may be used to indicate a synchronous state and an asynchronous state. For example, whether the plurality of QoS flows are configured for meeting the synchronization requirement during transmission may be indicated, according to a latency monitoring result for the plurality of QoS flows, using different states of a state machine. The state machine includes a synchronous state and an asynchronous state. The state machine may also include other states, for example, an about-to-be asynchronous state, a slight asynchronous state, and a severe asynchronous state. These states may be set according to the degree of QoS flow latency.

S540: Adjust, if it is monitored that the plurality of QoS flows are not configured for meeting the synchronization requirement during transmission, a transmission resource allocation status for the plurality of QoS flows.

In some embodiments, if a particular QoS flow has a relatively large transmission latency, more transmission resources may be allocated to the QoS flow, or a relatively idle transmission link may be allocated to the QoS flow, to reduce the latency of the QoS flow. If the plurality of QoS flows are still not configured for meeting the synchronization requirement after the transmission resource allocation status for the plurality of QoS flows is adjusted and after a set duration, a notification may be transmitted to the core network element such that the core network element adjusts the transmission parameter for the plurality of QoS flows. For example, the core network element may adjust the QoS parameter for the plurality of QoS flows using a PDU session modification procedure or adjust the synchronization parameter among the QoS flows.

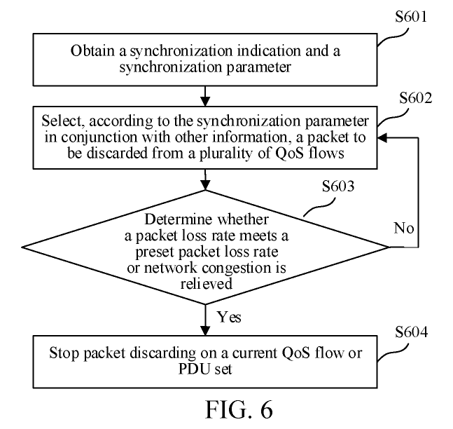

The implementation details of the technical solution in the embodiments of this disclosure are described in further detail below in an example of a 5G system with reference to FIG. 6.

In the technical solution of this embodiment of this disclosure, the synchronization relationship among QoS flows may be recognized at a next generation radio access network (NG-RAN) gNB. During data transmission, redundant data is discarded from a plurality of data flows according to synchronization among the QoS flows, thereby providing a more intelligent packet discarding mechanism for multimodal data flows having a synchronization requirement, better dealing with congestion, and improving the capability of dealing with network congestion in subsequent evolved systems such as 5G, 5G-A, and 6G networks. In some examples, referring to FIG. 6, the following operations are included:

S601: An NG-RAN obtains a synchronization indication and a synchronization parameter.

In some embodiments, the NG-RAN may obtain one or more pieces of synchronization indication information among the QoS flows from a 5G core (5GC) network element such as a policy control function (PCF), a session management function (SMF), or an access and mobility management function (AMF). The synchronization indication information may include a synchronization indication, a synchronization parameter, and the like.

For example, the synchronization indication may be configured for indicating a plurality of QoS flows having a synchronization relationship. In some examples, the core network element may provide the synchronization relationship among the plurality of QoS flows to the NG-RAN by indicating different QoS flows in the same PDU session or associating the plurality of QoS flows in different PDU sessions.

The synchronization parameter is configured for representing a synchronization requirement among a plurality of QoS flows, and for example, may be a specific synchronization requirement parameter threshold. The synchronization parameter may be defined as a maximum synchronization time difference between different QoS flows, for example, 20 ms. Therefore, the time synchronization difference between QoS flow 1 and QoS flow 2 does not exceed 20 ms.

After the NG-RAN obtains the synchronization indication and the synchronization parameter, one or more DRBs may be used to perform data transmission and monitor the latency among different service flows.

In some embodiments, to ensure synchronization among the plurality of QoS flows, when the plurality of data flows can use the same 5QI, or use the same PDB indicator, or use the same PDU indicator, PER indicator, or MDBV indicator, or when the NG-RAN determines that QoS of the plurality of service flows can be ensured even if the same DRB is used, the same DRB may be used for transmission. The same DRB can achieve the same latency characteristic.

In some embodiments, different QoS flows may have different characteristics. For example, different QoS flows may include different XRM media streams/types, or include different PDU sets that have different PDU set importances (PSIs), or have the same latency but different PERs (that is, the different QoS flows have different reliability indicators). These factors make it impossible to use the same DRB. In the foregoing cases, the NG-RAN may use different DRBs to transmit the plurality of QoS flows.

In some embodiments, to ensure that different QoS flows can meet the same latency indicator, the gNB may perform latency monitoring on the plurality of QoS flows having a synchronization indicator requirement. For example, in an RLC UM mode, in a case of uplink (UL) transmission, the latency may be monitored by a receive (RX) RLC instance, and in a case of downlink (DL) transmission, the latency may be monitored by a transmit (TX) RLC instance.

For example, in an RLC AM mode, if the UL and the DL share an RLC instance, whether the latency of a plurality of QoS flow service flows can meet a synchronization requirement can be analyzed by analyzing the trend of sequence number latency variations using the RLC instance.

In some embodiments, if the NG-RAN detects that transmission among the plurality of QoS flows can meet the synchronization requirement, the NG-RAN may continue transmission. If the transmission cannot meet the synchronization requirement, the NG-RAN may adjust a resource transmission algorithm to enable the plurality of QoS flows to meet the synchronization requirement. If the synchronization requirement still cannot be met within a set duration, the NG-RAN may transmit a notification to a 5G core (5GC), so that after receiving the notification that the synchronization requirement cannot be met, the 5GC triggers an update of the QoS flow parameters.

For example, after receiving the notification that the synchronization requirement cannot be met, the 5GC may transmit a notification that synchronization among a plurality of QoS flows cannot be met to the AF, so that the AF may make adaptive adjustment. For example, the AF regenerates QoS requirement information for the plurality of QoS flows and transmits the QoS requirement information to the core network element, to adjust the processing policy for the plurality of QoS flows.

In some embodiments, whether the plurality of QoS flows meet the synchronization requirement may be determined in a per-packet manner or once per MAC TB transmission. However, this determining manner may not be suitable for a case in which a radio channel changes seriously. Therefore, to improve system scalability, the determination of the synchronization requirement may be designed as a state machine or threshold-based determination, which is implemented in a user plane RLC or MAC instance.

In some examples, when the determination is performed based on a threshold, a threshold may be set. When the latency variation of data packet transmission is within a threshold range, the synchronization requirement is met, and no reporting process is triggered. If the latency variation of data packet transmission exceeds the threshold range, the synchronization requirement is not met, and the reporting process needs to be triggered.

When the determination is performed based on a state machine, a state machine may be designed. The state machine includes a synchronous state and an asynchronous state, or may also include other states, to dynamically change with a latency state of data packet transmission.

In some embodiments, the state machine-based determination and the threshold-based determination may be jointly implemented, or may be separately implemented.

Still referring to FIG. 6, S602: The NG-RAN may select, according to the synchronization parameter in conjunction with other information, a packet to be discarded from a plurality of QoS flows.

In some embodiments, if poor network transmission quality is detected, the NG-RAN may select, according to the synchronization parameter in conjunction with other information, a packet to be discarded from a plurality of QoS flows. For example, some data packets in the QoS flows that do not meet the synchronization requirement may be preferentially discarded. For example, when an audio stream and a video stream are synchronously transmitted, if the audio stream has a large latency and cannot be synchronized with the video stream, some data packets in the audio stream may be preferentially discarded when network quality is poor. In this way, the data packets in the audio stream that do not meet the synchronization requirement can be discarded, and the data packets in the audio stream that can be synchronized with the video stream can be transmitted, thereby better maintaining time consistency of multimodal data flows, and helping ensure quality of user experience.

In some embodiments, if it is determined, according to the network transmission quality, that packet discarding needs to be performed, but it is determined, according to the synchronization parameter among the plurality of QoS flows, that the plurality of QoS flows meet the synchronization requirement, some data packets in the plurality of QoS flows may be discarded according to an ascending order of priorities of the data packets. In other words, if it is determined, according to the network transmission quality, that packet discarding needs to be performed, some data packets in the QoS flows that do not meet the synchronization requirement may be preferentially discarded, and if all the QoS flows meet the synchronization requirement, the data packets are discarded according to an ascending order of priorities of the data packets. For example, when the data packets in the plurality of QoS flows are discarded in the ascending order of the priorities of the data packets in the plurality of QoS flows, packet discarding may be performed on each QoS flow in an ascending order of the priorities of the data packets; or packet discarding may be performed on some QoS flows (for example, randomly selected QoS flows or QoS flows with lower priority) in the plurality of QoS flows according to an ascending order of priorities of the data packets; or the data packets in the plurality of QoS flows may be put together, and packet discarding is performed according to an ascending order of the priorities.

S603: Determine whether a packet loss rate meets a preset packet loss rate or network congestion is relieved. If so, S604 is performed. Otherwise, packet discarding in S602 is performed.

In some embodiments, in the packet discarding process, if it is detected that the network congestion is relieved and the network transmission quality returns to normal, the packet discarding on the plurality of QoS flows may be stopped.

In some embodiments, in the packet discarding process, if it is detected that the packet loss rate of a QoS flow reaches a set tolerable packet loss proportion, the packet discarding on the QoS flow may be stopped. The tolerable packet loss proportion is configured for representing a maximum allowable packet loss proportion, which may be, for example, a maximum proportion of data packets that are allowed to be discarded on the premise of ensuring that the data receiving end can normally decode the other data packets in the service data flow. Alternatively, when it is detected that the packet loss rate of a PDU set reaches a set tolerable packet loss proportion, the packet discarding on the PDU set may be stopped. In the technical solution of this embodiment, when a proportion of the discarded data packets in a QoS flow (or a PDU set) reaches a set tolerable packet loss proportion, the data packets in the QoS flow (or the PDU set) are no longer discarded. This prevents excessive packet loss from rendering the data receiving end incapable of recovering the other data packets in the QoS flow (or the PDU set).

S604: Stop packet discarding on a current QoS flow or PDU set.

According to the technical solution of the foregoing embodiments of this disclosure, the synchronization parameter can be introduced to make packet discarding decisions for the plurality of QoS flows, and a more intelligent packet discarding mechanism among the plurality of QoS flows having the synchronization relationship is implemented, so that synchronization among different QoS flows and overall service quality can be maintained in a case of network congestion.

The technical solution in the embodiments of this disclosure is applicable not only to the 5G system, but also to a future evolved mobile communication system. In addition, the technical solution in the embodiments of this disclosure may be applied not only to a data transmission process performed by the NG-RAN, but also to a data transmission process performed by other devices (such as a terminal device or a UPF).

The following describes an apparatus embodiment of this disclosure, which can be configured to perform the data transmission method in the foregoing embodiment of this disclosure. For details undisclosed in the apparatus embodiments of this disclosure, reference is made to the embodiments of the foregoing data transmission method in this disclosure.

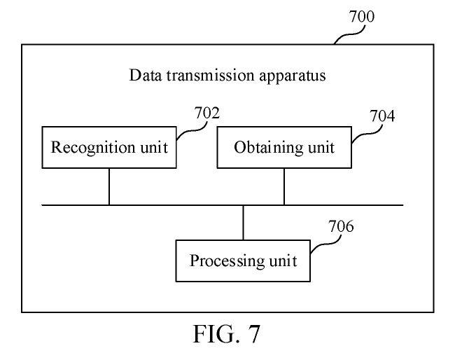

FIG. 7 is a block diagram of a data transmission apparatus according to various embodiments of this disclosure. The data transmission apparatus may be applied to an access network element, for example, a gNB device. The data transmission apparatus shown in FIG. 7 may also be applied to another electronic device (such as a user equipment or a UPF) having a computing processing function.

Referring to FIG. 7, a data transmission apparatus 700 according to various embodiments of this disclosure includes a recognition unit 702, an obtaining unit 704, and a processing unit 706.

The recognition unit 702 is configured to recognize a synchronization relationship among a plurality of QoS flows. The obtaining unit 704 is configured to obtain, if the synchronization relationship among the plurality of QoS flows is recognized, a synchronization parameter among the plurality of QoS flows. The processing unit 706 is configured to discard, if it is determined, according to network transmission quality, that packet discarding needs to be performed, a target data packet in the plurality of QoS flows according to the synchronization parameter.

In some embodiments of this disclosure, based on the foregoing solution, the processing unit 706 is configured to: determine, according to a synchronization requirement determined by the synchronization parameter, a target QoS flow in the plurality of QoS flows that does not meet the synchronization requirement with respect to the other QoS flows; and select one or more data packets in the target QoS flow as the target data packet.

In some embodiments of this disclosure, based on the foregoing solution, the processing unit 706 is configured to: determine, if it is detected that a transmission latency between the target QoS flow and the other QoS flows in the plurality of QoS flows is greater than or equal to a latency threshold indicated by the synchronization parameter, that the target QoS flow does not meet the synchronization requirement with respect to the other QoS flows.

In some embodiments of this disclosure, based on the foregoing solution, the processing unit 706 is configured to: select, if it is determined, according to the synchronization requirement determined by the synchronization parameter, that the plurality of QoS flows meet the synchronization requirement, one or more data packets from the data packets in the plurality of QoS flows according to an ascending order of priorities of the data packets in the plurality of QoS flows as the target data packet.

In some embodiments of this disclosure, based on the foregoing solution, the recognition unit 702 is configured to: receive indication information transmitted by a core network element, and recognize, according to the indication information, whether the plurality of QoS flows in a same protocol data unit (PDU) session have the synchronization relationship, or whether the plurality of QoS flows in different PDU sessions have the synchronization relationship; or search a user equipment (UE) context for a QoS parameter associated with a specific session, and then recognize, based on the QoS parameter, whether the plurality of QoS flows have the synchronization relationship; or recognize, according to a QoS parameter of a QoS flow level, whether the plurality of QoS flows have the synchronization relationship.

In some embodiments of this disclosure, based on the foregoing solution, the obtaining unit 704 is configured to: receive indication information of the synchronization parameter transmitted by the core network element, and obtain, based on the indication information of the synchronization parameter, a threshold of a synchronization time difference among the plurality of QoS flows. The threshold is configured for indicating a maximum time synchronization error among the plurality of QoS flows.

In some embodiments of this disclosure, based on the foregoing solution, the processing unit 706 is further configured to: transmit, according to the synchronization relationship, the plurality of QoS flows using a same data radio bearer such that the plurality of QoS flows meet the synchronization requirement when being transmitted based on the same data radio bearer, the synchronization requirement being preset or indicated; or allocate, according to the synchronization relationship, different data radio bearers to the plurality of QoS flows such that the plurality of QoS flows meet the synchronization requirement when being transmitted based on the different data radio bearers. The synchronization requirement is preset or indicated.

In some embodiments of this disclosure, based on the foregoing solution, the processing unit 706 is further configured to: perform, according to the synchronization relationship, resource allocation on the plurality of QoS flows such that the plurality of QoS flows meet the synchronization requirement when being transmitted based on allocated transmission resources; perform, after the performing, according to the synchronization relationship, resource allocation on the plurality of QoS flows, latency monitoring on transmission processes of the plurality of QoS flows; and adjust, if it is detected in the latency monitoring that the plurality of QoS flows are not configured for meeting the synchronization requirement during transmission, a transmission resource allocation status for the plurality of QoS flows.

In some embodiments of this disclosure, based on the foregoing solution, the processing unit 706 is configured to: perform, if a transmission mode of the plurality of QoS flows is an unacknowledged mode, latency monitoring on an uplink transmission process of the plurality of QoS flows by a radio link control (RLC) instance configured to receive the plurality of QoS flows, and perform latency monitoring on a downlink transmission process of the plurality of QoS flows by an RLC instance configured to transmit the plurality of QoS flows; and perform, if the transmission mode of the plurality of QoS flows is an acknowledged mode, latency monitoring on the transmission processes of the plurality of QoS flows by an RLC instance configured to receive the plurality of QoS flows and transmit the plurality of QoS flows.

In some embodiments of this disclosure, based on the foregoing solution, the processing unit 706 is configured to: monitor, for the plurality of QoS flows, whether the plurality of QoS flows meet the synchronization requirement using a data packet as a unit; or monitor, for the plurality of QoS flows, whether the plurality of QoS flows meet the synchronization requirement using a transport block as a unit.

In some embodiments of this disclosure, based on the foregoing solution, the processing unit 706 is configured to: determine, if a transmission latency among the data packets of the plurality of QoS flows is within a set threshold range, that the plurality of QoS flows are configured for meeting the synchronization requirement during transmission; or determine, if the transmission latency among the data packets of the plurality of QoS flows is not within the set threshold range, that the plurality of QoS flows are not configured for meeting the synchronization requirement during transmission.

In some embodiments of this disclosure, based on the foregoing solution, the processing unit 706 is configured to: indicate, according to a latency monitoring result of the plurality of QoS flows, whether the plurality of QoS flows are configured for meeting the synchronization requirement during transmission using different states of a state machine. The state machine includes a synchronous state and an asynchronous state.

In some embodiments of this disclosure, based on the foregoing solution, the processing unit 706 is further configured to: transmit, if the plurality of QoS flows are still not configured for meeting the synchronization requirement after the transmission resource allocation status for the plurality of QoS flows is adjusted and after a set duration, a notification to the core network element such that the core network element adjusts the synchronization parameter for the plurality of QoS flows.

In some embodiments of this disclosure, based on the foregoing solution, the processing unit 706 is further configured to: stop, if it is detected that a proportion of data packets discarded in any of the plurality of QoS flows reaches a set tolerable packet loss proportion, the packet discarding on the QoS flow. The tolerable packet loss proportion is configured for indicating a maximum allowable packet loss proportion.

In some embodiments of this disclosure, based on the foregoing solution, the processing unit 706 is further configured to: stop, if it is detected that the network transmission quality returns to normal, the packet discarding on the plurality of QoS flows.

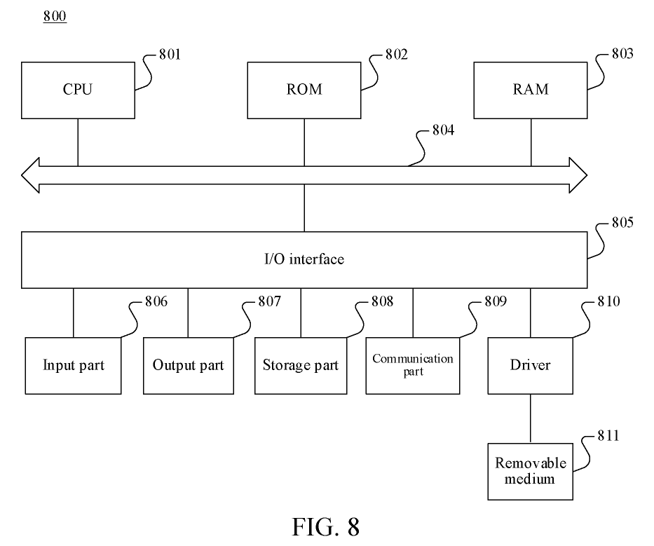

FIG. 8 is a schematic structural diagram of a computer system adapted to implement an electronic device according to an embodiment of this disclosure. The electronic device may be the access network element in the foregoing embodiments, such as the gNB device.

A computer system 800 of the electronic device shown in FIG. 8 is an example, and does not constitute any limitation on functions and use ranges of the embodiments of this disclosure.

As shown in FIG. 8, the computer system 800 includes a central processing unit (CPU) 801, which may perform various suitable actions and processing based on a program stored in a read-only memory (ROM) 802 or a program loaded from a storage part 808 into a random access memory (RAM) 803, for example, perform the method described in the foregoing embodiments. The RAM 803 further stores various programs and data required for system operations. The CPU 801, the ROM 802, and the RAM 803 are connected to each other through a bus 804. An input/output (I/O) interface 805 is also connected to the bus 804.

The following components may be connected to the I/O interface 805: an input part 806 including a keyboard, a mouse, or the like; an output part 807 including a cathode ray tube (CRT), a liquid crystal display (LCD), a speaker, or the like; a storage part 808 including a hard disk, or the like; and a communication part 809 including a network interface card such as a local area network (LAN) card or a modem. The communication part 809 performs communication processing using a network such as the Internet. A driver 810 is also connected to the I/O interface 805 as required. A removable medium 811, such as a magnetic disk, an optical disc, a magneto-optical disk, or a semiconductor memory, is installed on the driver 810 as required, so that a computer program read from the removable medium is installed into the storage part 808 as required.

In some examples, according to an embodiment of this disclosure, the processes described above with reference to the flowcharts may be implemented as computer software programs. For example, an embodiment of this disclosure provides a computer program product, which includes a computer program carried on a computer-readable medium. The computer program is configured for performing the method shown in the flowchart. In such an embodiment, the computer program may be downloaded and installed from a network through the communication part 809, and/or installed from the removable medium 811. When the computer program is executed by the CPU 801, the various functions defined in the system of this disclosure are executed.

The computer-readable medium shown in the embodiments of this disclosure may be a computer-readable signal medium or a computer-readable storage medium (e.g., non-transitory computer-readable storage medium) or any combination of the two. The computer-readable storage medium may be, for example, but is not limited to, an electric, magnetic, optical, electromagnetic, infrared, or semi-conductive system, apparatus, or device, or any combination of the above. A more specific example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this disclosure, the computer-readable storage medium may be any tangible medium containing or storing a computer program, and the computer program may be used by or used in combination with an instruction execution system, apparatus, or device. In this disclosure, the computer-readable signal medium may include a data signal transmitted in a baseband or as part of a carrier, and stores a computer-readable computer program. A data signal propagated in such a way may assume a plurality of forms, including, but not limited to, an electromagnetic signal, an optical signal, or any appropriate combination thereof. The computer-readable signal medium may be further any computer-readable medium in addition to a computer-readable storage medium. The computer-readable medium may transmit, propagate, or transmit a program that is used by or used in conjunction with an instruction execution system, an apparatus, or a device. The computer program included in the computer-readable medium may be transmitted using any suitable medium, including but not limited to wireless, wired, or the like, or any suitable combination thereof.

The flowcharts and block diagrams in the accompanying drawings illustrate possible system architectures, functions and operations that may be implemented by a system, a method, and a computer program product according to various embodiments of this disclosure. Each box in a flowchart or a block diagram may represent a module, a program segment, or a part of code. The module, the program segment, or the part of code includes one or more executable instructions used for implementing specified logic functions. In some implementations used as substitutes, functions annotated in boxes may alternatively occur in a sequence different from that annotated in an accompanying drawing. For example, actually two boxes shown in succession may be performed basically in parallel, and sometimes the two boxes may be performed in a reverse sequence. This is determined by a related function. Each box in a block diagram and/or a flowchart and a combination of boxes in the block diagram and/or the flowchart may be implemented using a dedicated hardware-based system used to perform a specified function or operation, or may be implemented using a combination of dedicated hardware and a computer program.

A related unit described in the embodiments of this disclosure may be implemented in a software manner, or may be implemented in a hardware manner, and the unit described can also be set in a processor. Names of the units do not constitute a limitation on the units in a specific case.

According to another aspect, this disclosure further provides a computer-readable medium. The computer-readable medium may be included in the electronic device described in the foregoing embodiments, or may exist alone and is not installed in the electronic device. The foregoing computer-readable medium carries one or more computer programs. The one or more computer programs, when executed by the electronic device, cause the electronic device to implement the method according to the foregoing embodiments.

Although a plurality of modules or units of a device configured to perform actions are discussed in the foregoing detailed description, such division is not mandatory. Actually, according to the implementations of this disclosure, the features and functions of two or more modules or units described above may be specifically implemented in one module or unit. On the contrary, the features and functions of one module or unit described above may be further divided to be embodied by a plurality of modules or units.

According to the foregoing descriptions of the implementations, a person skilled in the art may readily understand that the implementations described herein may be implemented using software, or may be implemented by combining software and appropriate hardware. Therefore, the technical solutions in the implementations of this disclosure may be implemented in the form of software product. The software product may be stored in a non-volatile storage medium (which may be a CD-ROM, a Universal Serial Bus (USB) flash drive, a removable hard disk, or the like) or on a network, including several instructions to cause an electronic device to perform the method according to the implementations of this disclosure. For example, the electronic device may be an access network element, and then the access network element may perform the data transmission method shown in FIG. 4 to FIG. 5.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of data transmission, comprising: recognizing a synchronization relationship among a plurality of quality of service (QoS) flows; obtaining, when the synchronization relationship among the plurality of QoS flows is recognized, a synchronization parameter associated with the plurality of QoS flows; selecting, when a network transmission quality indicates a need for packet discarding, at least a target QoS flow in the plurality of QoS flows that fails to satisfy a synchronization requirement to other QoS flows in the plurality of QoS flows based on the synchronization parameter; and discarding, at least a target data packet in the target QoS flow.

2. The method according to claim 1, wherein the selecting comprises: determining, when a transmission latency between the target QoS flow and the other QoS flows in the plurality of QoS flows is greater than or equal to a latency threshold that is indicated by the synchronization parameter, that the target QoS flow does not satisfy the synchronization requirement to the other QoS flows.

3. The method according to claim 1, further comprising: selecting, when the plurality of QoS flows satisfy the synchronization requirement that is indicated by the synchronization parameter, the target data packet from data packets in the plurality of QoS flows according to an ascending order of priorities of the data packets in the plurality of QoS flows.

4. The method according to claim 1, wherein the recognizing the synchronization relationship comprises: receiving indication information that is transmitted by a core network element; and recognizing, according to the indication information, whether the plurality of QoS flows in a same protocol data unit (PDU) session have the synchronization relationship, or whether the plurality of QoS flows in different PDU sessions have the synchronization relationship.

5. The method according to claim 1, wherein the recognizing the synchronization relationship comprises: searching a user equipment (UE) context for a QoS parameter associated with a specific session, and recognizing, based on the QoS parameter, whether the plurality of QoS flows have the synchronization relationship.

6. The method according to claim 1, wherein the recognizing the synchronization relationship comprises: recognizing, according to QoS parameters of QoS flow level, whether the plurality of QoS flows have the synchronization relationship.

7. The method according to claim 1, wherein the obtaining the synchronization parameter comprises: receiving indication information of the synchronization parameter that is transmitted by a core network element, and obtaining, based on the indication information of the synchronization parameter, a threshold of a synchronization time difference among the plurality of QoS flows, the threshold indicating a maximum time synchronization error among the plurality of QoS flows.

8. The method according to claim 1, further comprising: transmitting, according to the synchronization relationship, the plurality of QoS flows using a same data radio bearer to cause the plurality of QoS flows to satisfy the synchronization requirement.

9. The method according to claim 1, further comprising: allocating, according to the synchronization relationship, different data radio bearers to the plurality of QoS flows to cause the plurality of QoS flows to satisfy the synchronization requirement.

10. The method according to claim 1, further comprising: performing, according to the synchronization relationship, resource allocation to the plurality of QoS flows based on the synchronization requirement; performing latency monitoring on transmission processes of the plurality of QoS flows; and adjusting, when the latency monitoring indicates that the plurality of QoS flows fail to satisfy the synchronization requirement during the transmission processes, the resource allocation to the plurality of QoS flows.

11. The method according to claim 10, wherein the performing the latency monitoring comprises: when a transmission mode of the plurality of QoS flows is an unacknowledged mode, performing a first latency monitoring on an uplink transmission process of the plurality of QoS flows by a first radio link control (RLC) instance configured to receive the plurality of QoS flows, and performing a second latency monitoring on a downlink transmission process of the plurality of QoS flows by a second RLC instance configured to transmit the plurality of QoS flows.

12. The method according to claim 11, wherein the performing the latency monitoring comprises: when the transmission mode of the plurality of QoS flows is an acknowledged mode, performing the latency monitoring on the transmission processes of the plurality of QoS flows by an RLC instance configured to receive the plurality of QoS flows and transmit the plurality of QoS flows.

13. The method according to claim 10, wherein the performing the latency monitoring comprises: monitoring, on a per data packet basis, whether the plurality of QoS flows satisfy the synchronization requirement; or monitoring, on a per transport block basis, whether the plurality of QoS flows satisfy the synchronization requirement.

14. The method according to claim 10, wherein the performing the latency monitoring comprises: determining, when a transmission latency among data packets of the plurality of QoS flows is within a threshold range, that the plurality of QoS flows satisfy the synchronization requirement; or determining, when the transmission latency among the data packets of the plurality of QoS flows is not within the threshold range, that the plurality of QoS flows fail to satisfy the synchronization requirement.

15. The method according to claim 10, wherein the performing the latency monitoring comprises: indicating, according to a latency monitoring result of the plurality of QoS flows, whether the plurality of QoS flows satisfy the synchronization requirement by using different states of a state machine, the state machine comprising at least a synchronous state and an asynchronous state.

16. The method according to claim 10, further comprising: transmitting, when the plurality of QoS flows fail to satisfy the synchronization requirement after a preset duration from an adjustment of transmission resource allocation for the plurality of QoS flows, a notification to a core network element to cause the core network element to adjust the synchronization parameter for the plurality of QoS flows.

17. The method according to claim 1, further comprising at least one of: stopping, when a proportion of data packets discarded in a QoS flow in the plurality of QoS flows reaches a tolerable packet loss proportion, discarding packet in the QoS flow, the tolerable packet loss proportion indicating a maximum allowable packet loss proportion; and stopping, when the network transmission quality returns to normal, discarding packet in the plurality of QoS flows.

18. An apparatus for data transmission, comprising processing circuitry configured to: recognize a synchronization relationship among a plurality of quality of service (QoS) flows; obtain, when the synchronization relationship among the plurality of QoS flows is recognized, a synchronization parameter associated with the plurality of QoS flows; select, when a network transmission quality indicates a need for packet discarding, at least a target QoS flow in the plurality of QoS flows that fails to satisfy a synchronization requirement to other QoS flows in the plurality of QoS flows based on the synchronization parameter; and discard, at least a target data packet in the target QoS flow.

19. The apparatus according to claim 18, wherein the processing circuitry is configured to: determine, when a transmission latency between the target QoS flow and the other QoS flows in the plurality of QoS flows is greater than or equal to a latency threshold that is indicated by the synchronization parameter, that the target QoS flow does not satisfy the synchronization requirement to the other QoS flows.

20. A non-transitory computer-readable storage medium storing instructions which when executed by a processor cause the processor to perform: recognizing a synchronization relationship among a plurality of quality of service (QoS) flows; obtaining, when the synchronization relationship among the plurality of QoS flows is recognized, a synchronization parameter associated with the plurality of QoS flows; selecting, when a network transmission quality indicates a need for packet discarding, at least a target QoS flow in the plurality of QoS flows that fails to satisfy a synchronization requirement to other QoS flows in the plurality of QoS flows based on the synchronization parameter; and discarding, at least a target data packet in the target QoS flow.
